(19) United States
(12) Patent Application Publication
(10) Pub. No.: US 2010/0226087 A1
(43) Pub. Date: Sep. 9, 2010

(54) COMPUTER SYSTEM WITH INTEGRATED CABLE

(75) Inventors: Tzu-Wei Tai, Taipei (TW); Ya-Chyi Chou, Taipei (TW); Hsing-Cheng Liu, Taipei (TW); Yen-Ting Liu, Taipei (TW); Po-Yang Shih, Taipei (TW); Cheng-Han Chang, Taipei (TW); Ting-Kuo Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/715,387

(22) Filed: Mar. 2, 2010

(30) Foreign Application Priority Data
Mar. 6, 2009 (TW) 98107359

(51) Int. Cl. G06F 1/16

(52) U.S. Cl. 361/679.33; 361/679.02

(57) ABSTRACT

A computer system with integrated cable is disclosed. The computer system includes a circuit board module, at least one electronic device and an integrated cable. The circuit board module includes a first connector, and the integrated cable is electrically connecting with the circuit board module and the electronic device. The integrated cable includes a second connector electrically connected to the first connector and a body electrically connected to the electronic device. The body integrates at least one power cable and at least one signal cable electrically connected to the second connector, and has a tearing structure formed between the power cable and the signal cable to allow an easy separation of the power cable and the signal cable. With such, meanwhile, entwining of unused power cables or signal cables is effectively avoided.

### CROSS-REFERENCE TO RELATED APPLICATION

This application claims the priority benefit of Taiwan application serial no. 98107359, filed on Mar. 6, 2009. The entirety of the above-mentioned patent application is hereby incorporated by reference herein and made a part of specification.

### BACKGROUND OF THE INVENTION

1. Field of the Invention

The invention relates to a computer system and, more particularly, to a computer system with integrated cable.

2. Description of the Related Art

Present computer systems normally comprise electronic devices and peripheral devices such as motherboards, hard disk drives, interface cards and power supplies. Power cables and signal cables are connected between these devices to provide power or transmit signals. Since there are massive cross cables to work, the signal cables and the power cables are inevitably spread disorderly in the computer system. With such, heat dissipation of the electronic device may be reduced, and also, maintenance of the computer system may be handicapped.

In addition, not all the power cables and the signal cables in the computer system are in use all the time. For example, when the computer system is not equipped with an optical disk drive, the corresponding power cable and signal cable are left unused. Once the unused power cable and the signal cable entwining and obstructing a passive for heat dissipation, the computer system may easily overheated and crash. Generally, a user may use a tie, belt or strip to tie the cables. However, the tie, belt or strip is easy broken and is tedious to use. Thus, how to arrange the cables is a problem need to be solved.

### BRIEF SUMMARY OF THE INVENTION

The invention discloses a computer system, which has at least one integrated cables that is tidy and facilitating ordering.

The invention discloses a computer system with integrated cable. The computer system includes a circuit board module, at least one electronic device and an integrated cable. The circuit board module includes a first connector. The integrated cable is used for electrically connecting to the circuit board module and the electronic device and includes a second connector and a body. The second connector is electrically connected to the first connector. The body is electrically connected to the electronic device. The body integrates at least one power cable and at least one signal cable that electrically connected to the second connector, and has a tearing structure formed between the power cable and the signal cable to allow the power cable and the signal cable to be separated when using.

In an embodiment of the invention, the number of the electronic device is multiple, and the number of the power cables and the number of the signal cable are correspondingly multiple. When the electronic device, the power cable and the signal cable are plural, the power cable and the signal cable connect to the same electronic device have the same color, such that the power cables and the signal cables connecting to different electronic devices may be distinguished by colors. In the contrary, the color of the power cables and the signal cables are different when they electrically connected to different electronic devices.

In an embodiment of the invention, the signal cables are integrated device electronics (IDE) signal cables or serial advanced technology attachment (SATA) signal cables.

In an embodiment of the invention, the electronic device includes an optical disk drive, a hard disk drive or a solid state disk drive.

Based on the above, in the computer system with the integrated cable in the invention, since the integrated cable combines at least one power cable and a signal cable via a tearing structure formed between the power cable and the signal cable, the user may tear and separate the needed power cable or signal cable to connect with corresponding electronic device. Thus, arrangement of the cables will be more tidy and easily ordered.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the computer system in an embodiment of the invention;

FIG. 2 is a sectional diagram showing the integrated cable in FIG. 1 when the body is not separated;

FIG. 3 is a schematic diagram showing the computer system in another embodiment of the invention; and

FIG. 4 is a sectional diagram showing the integrated cable in FIG. 3 when the body is not separated.

### DETAILED DESCRIPTION OF THE EMBODIMENTS

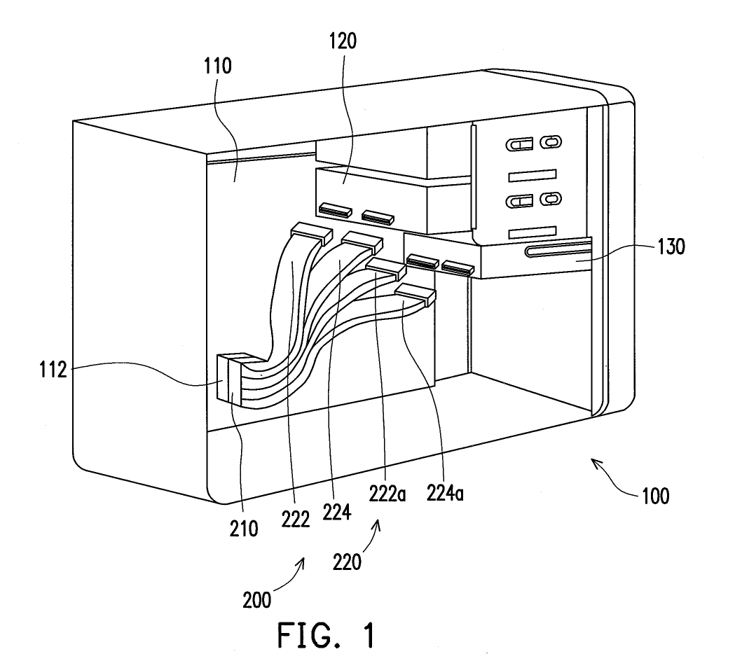

FIG. 1 is a schematic diagram showing a computer system in an embodiment of the invention. The computer system 100 includes a circuit board module 110, two electronic devices 120 and 130 and an integrated cable 200. The circuit board module 110 includes a first connector 112. The integrated cable 200 includes a second connector 210 and a body 220. The second connector 210 is electrically connected to the first connector 112. The body 220 is electrically connected to the electronic device 120 and integrates power cables 222 and 222a and signal cables 224 and 224a. The power cables 222 and 222a and the signal cables 224 and 224a are electrically connected to the second connector 210.

Wherein The power cables 222 and 222a and the signal cables 224 and 224a are respectively bound together by a perforated tearing structure 226 that formed for efficient unbinding the cables if required.

In the embodiment, the circuit board module 110 may be a motherboard, and the first connector 112 is disposed on the circuit board module 110. The first connector 112 has power terminals (not shown) and signal terminals (not shown). The electronic devices 120 and 130 may be an optical disk drive, a hard disk drive or a solid disk drive. The first connector 112 is electrically connected to the second connector 210 to provide power to the electronic devices 120 and 130 via the integrated cable 200, or transmit signals to the electronic devices 120 and 130. Similarly, the second connector 210 has power terminals and signal terminals. With the correspondence between the connectors 112 and 210, when the user installs the electronic device 120 and 130, he or she does not need to search for separated corresponding power connector or the signal connector on the circuit board module 110. Thus, the assembling process is much easier.

In the invention, the number of the electronic devices 120 and 130, the number of the power cables 222 and 222a and the number of the signal cables 224 and 224a in the integrated cable 200 are not limited. The designer may decide them according to the containing space of the computer system 100. In the embodiment, two electronic devices 120 and 130, two power cables 222 and 222a and two signal cables 224 and 224a are taken as an example.

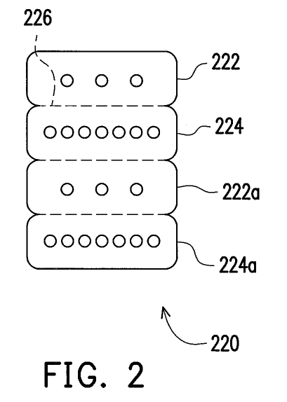

FIG. 2 is a sectional diagram showing the integrated cable in FIG. 1 when the body is not separated. As shown in FIG. 1 and FIG. 2, the body 220 has a tearing structure 226 formed between the power cables 222 and 222a and the signal cables 224 and 224a thus to allow the power cable 222 and 222a and the signal cables 224 and 224a to be separated if required. Therefore, in the embodiment, the user may select the corresponding power cables 222 and 222a and the signal cables 224 and 224a according to the types of the electronic devices 120 and 130 in the computer system 100. The power cables 222 and 222a and the signal cables 224 and 224a are separated and electrically connected to the corresponding electronic devices 120 and 130.

In the computer system 100 in the embodiment of the invention, the power cables 222 and 222a and the signal cables 224 and 224a are integrated, and the user does not need to pay much time in looking for the corresponding power cables 222 and 222a or the signal cables 224 and 224a after the electronic devices 120 and 130 are installed. This brings the user much convenience. In addition, since the integrated cable 200 has the tearing structure 226, the user may select and separate needed power cables 222 and 222a or signal cables 224 and 224a as required, while still allows the rest that are unused be in combining status. Thus, the space in the computer system 100 may be saved and tidied, and therefore guarantees a passive for heat dissipation of the computer system 100. In addition, it is easy for the user to connect the electronic devices 120 and 130 with the circuit board module 110.

In present embodiment, the tearing structure 226 formed between the power cables 222 and 222a and the signal cables 224 and 224a is punctured at random intervals along which to allow the power cable 222 and 222a and the signal cables 224 and 224a to be separated easily by the user. However, the style of the tearing structure 226 is not limited, and any structures which may facilitate a separation are within the scope of the invention. As for the manufacture, for example, multiple protrusions may be formed in the mold and at the position corresponding to a common boundary between the power cables 222 and 222a and the signal cables 224 and 224a. Thus, perforated structure is formed between the power cables 222 and 222a and the signal cables 224 and 224a after the injecting molding process. With such, the user may slit the power cables 222 and 222a and the signal cables 224 and 224a easily.

Otherwise, the power cables 222 and 222a and the signal cables 224 and 224a also may be manufactured individually in advance, and then combined together via adhering means. In such manner, gaps may be remained in the connecting portion between the power cables 222 and 222a and the signal cables 224 and 224a. Also, glue having lower stickiness also may be applied to allow the power cables 222 and 222a and the signal cables 224 and 224a to be separated easily.

In the embodiment, to identify the power cables 222 and 222a and the signal cables 224 and 224a, the cables electrically connected to the same electronic device 120 or 130 may have the same color, and the cables electrically connected to different electronic devices 120 or 130 may be designed to have different colors. For example, in the embodiment, the electronic devices 120 and 130 may be an optical disk drive and a hard disk drive, respectively. Thus, the color of the power cable 222 and the signal cable 224 connected to the optical disk drive are same, and the color of the power cable 222a and the signal cable 224a connected to the hard disk drive also are same. However, the color of the power cable 222 is different from that of the power cable 222a. Then, the user may know that the power cables 222 and 222a and the signal cables 224 and 224a correspond to different electronic devices 120 and 130 according to the colors, and the cables would not be mistaken.

In another aspect, with the progress of the transmitting technology, electronic devices 120 and 130 having different transmitting interfaces may be located in a computer system 100. In the embodiment, the electronic device 120 is an optical disk drive, and it has an IDE transmitting interface. The electronic device 130 is a hard disk drive, and it has a SATA transmitting interface. Thus, to make the integrated cable 200 satisfy different transmission requirements for different transmission interfaces, the signal cables 224 and 224a respectively belong to the IDE signal cable and the SATA signal cable. Thus, the electronic devices 120 and 130 with different transmitting interfaces may be electrically connected to the circuit board module 110 via the integrated cable 200.

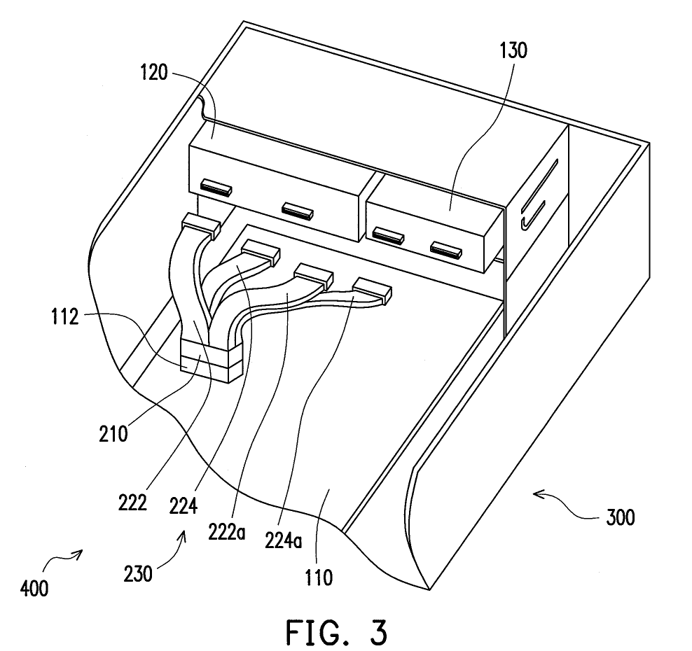

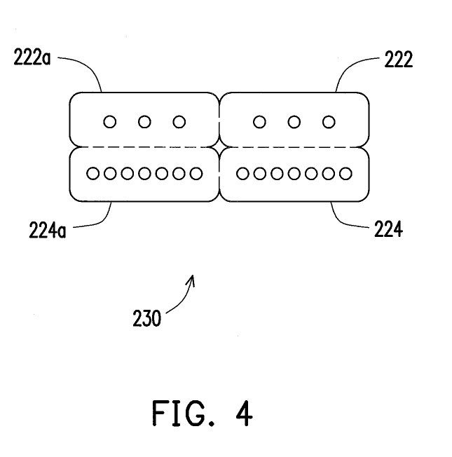

In addition, the appearance of the computer system 100 may be changed according to the requirement, and the positions of the electronic devices 120 and 130 inside the computer system 100 may be changed therewith. FIG. 3 is a schematic diagram showing the computer system in another embodiment of the invention. FIG. 4 is a sectional diagram showing the integrated cable in FIG. 3 in which the body is not separated. As shown in FIG. 3 and FIG. 4, the difference between this embodiment and the former embodiment is that, in this embodiment, the computer system 300 is disposed horizontally, and the electronic devices 120 and 130 also may be disposed horizontally according to the appearance of the computer system 300. Thus, in the integrated cable 400 in the embodiment, the power cables 222 and 222a and the signal cables 224 and the 224a of the body 230 also may be disposed horizontally to allow the user to connect the integrated cable 400 to the corresponding electronic devices 120 and 130 conveniently.

To sum up, in the computer system of the invention, since integrated cable integrates the power cables and the signal cables, and a tearing structure is formed between the power cables and the signal cables, the user may separate the power cables and the signal cables and electrically connect the cables to the corresponding electronic devices according to the requirements. This may overcome the disadvantage of having disordered cables in the computer system in the conventional technology, and also may reduce the space for putting the cables in the computer system. With such, meanwhile, entwining of unused power cables or signal cables is effectively avoided.

In addition, the power cable and the signal cable connected to the same electronic device have the same color, and the power cables and the signal cables connected to different electronic devices have different colors. Thus, the user may identify the power cables and the signal cables belonging to different electronic devices intuitively.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer system with integrated cable, comprising:
a circuit board module including a first connector;
at least one electronic device; and
an integrated cable for electrically connecting the circuit board module and the electronic device, the integrated cable including:
a second connector electrically connected to the first connector; and
a body electrically connected to the electronic device, wherein the body integrates at least one power cable and at least one signal cable, the power cable and the signal cable are electrically connected to the second connector, and the body has a tearing structure formed between the power cable and the signal cable to allow the power cable and the signal cable to be separated.

2. The computer system with integrated cable according to claim 1, wherein when the electronic device, the power cable and the signal cable are plural, the power cable and the signal cable connect to the same electronic device have the same color.

3. The computer system with integrated cable according to claim 1, wherein the signal cable is an integrated device electronics (IDE) signal cable or a serial advanced technology attachment (SATA) signal cable.

4. The computer system with integrated cable according to claim 1, wherein the electronic device is an optical disk drive, a hard disk drive or a solid state disk drive.
